(19) United States
(12) Patent Application Publication
(10) Pub. No.: US 2026/0355619 A1
(43) Pub. Date: Nov. 12, 2026

(54) AN APPLICATION AND A SYSTEM FOR DUAL CONTROL OF A GAME, AN APPLICATION AND A SYSTEM FOR DISPLAYING VIRTUAL BUTTONS, A SYSTEM FOR DETERMINING THE VALUE OF AT LEAST ONE PARAMETER OF THE USER'S FINGER, AND A SYSTEM FOR DETERMINING AND PRESENTING THE POSITION OF THE USER'S FINGER ON A DISPLAY

(71) Applicant: OUTPLAY SPÓLKA Z OGRANICZONA ODPOWIEDZIALNOSCIA, Skierniewice (PL)

(72) Inventor: Kamil Warulik, Skierniewice (PL)

(21) Appl. No.: 19/123,898

(22) PCT Filed: Oct. 24, 2023
(86) PCT No.: PCT/IB2023/060726

§ 371 Date: Apr. 24, 2025

(30) Foreign Application Priority Data
Oct. 24, 2022 (PL) 22461626.8

(51) Int. Cl. A63F 13/2145; A63F 13/211; A63F 13/212; A63F 13/235; A63F 13/45; A63F 13/92

(52) U.S. Cl. CPC A63F 13/2145; A63F 13/211; A63F 13/212; A63F 13/235; A63F 13/45; A63F 13/92

(57) ABSTRACT

The invention relates to an application and a system for dual control of a game, an application and a system for displaying data, and in particular video data, in the form of a context menu, a system for determining the value of at least one parameter of the user's finger, and a system for determining and presenting the position of the user's finger on a display.

### FIELD OF THE INVENTION

The invention relates to an application and a system for dual control of a game, an application and a system for displaying virtual buttons, a system for determining the value of at least one parameter of the user's finger, and a system for determining and presenting the position of the user's finger on a display. Systems, including software installed on a smartphone, allow for precisely displaying a pointer on a screen under the fingertip, after using it to hover over the screen, and for controlling a game by means of specified parameters of the finger. This is achieved by providing feedback information about the precise location of the finger with respect to the telephone screen, and about the kind of movement made by the finger.

### PRIOR ART

In prior art, there are numerous known wearable devices meant to monitor the position of the user's hand or finger. Many of them are based on the recognition of gestures for controlling a computer program or a VR environment. Due to this, the commands may be more intuitive, with no need to learn the rules of controlling complicated input systems.

An example of such a device is disclosed in document WO2019165139. This invention discloses a wearable device which, by using only the magnetic field, is capable of determining the position and the gestures of the user's hands and fingers on the basis of the bending of the joint. The device is capable of displaying a contour of the hand on the screen, while the tracing of the position of the device with respect to the screen has not been disclosed. Said method for locating elements provided with magnetic sensors may also be found useful in the technology of tablets.

Another document WO2019005586 discloses a device wearable on one of the fingers. It has optical, acceleration and pressure sensors, and it may connect wirelessly to other devices. Said device may trace the movement of fingers in a VR environment. The publication does not disclose any use of the invention with respect to touch screens, or to determining the position of the finger before touching the screen.

Another example of a device determining the position of the user's hand is disclosed in American patent U.S. Pat. No. 10,642,356. This invention discloses a device in the form of a flexible material comprising an acceleration sensor and a gyroscope. It is intended to determine the position and movements of the hands in space in order to transfer them to a VR environment. The method of monitoring the user's movements involves tracing the relative movement of at least two fingers by means of the device. No tracing of the movement with respect to external devices, such as a touch screen, is disclosed.

Document U.S. Pat. No. 10,579,099B2 discloses a system comprising a ring device. The ring device may have a housing adapted to be wearable on the user's finger. Sensors which can be used to collect input data from the user include force sensors, ultrasonic sensors, inertial measurement units, optical sensors, touch sensors and other elements. The control circuitry may wirelessly transmit information collected from sensors and other input devices to the associated electronic device. This information may be used to control the operation of the electronic device. The housing of the ring device may have an annular main body, and an expandable part connected to the main body. The expandable part may comprise a flap with a hinge, a rotatable housing element, a housing with an internal adjustable frame and a lid, an expandable housing made of an expandable tube connected between the first and the second ring device, and other expandable structures. The presented solution does not define the type of input which will be accomplished after touching and/or pressing the screen.

The inventions disclosed in the above documents focus on applications related to VR environments, detecting gestures on the basis of the movement of the hands. Moreover, the user does not receive any feedback information about the position of the finger. In the case of devices with a touch screen, the user is forced to enter a command by touching the touch screen, and subsequently correct the inputting position in accordance with the user's intentions. Prior art does not provide any solution allowing for the determination of the precise position of the user's fingers over the touch screen, and for displaying the determined position on the screen.

Therefore, one of the objectives of the present invention is to enable the user to stream the telephone screen to an external displaying device, and to perform precise actions on the display without looking at it, and instead by only looking at the external displaying device. It is then possible to maintain high responsibility and precision of gestures input into the application, displayed on an external display, with no need to check the position of the finger over the control device. In an embodiment comprising a button, e.g. disposed under the fingertip, it is even possible to transfer input gestures with no need to use a touch screen, which allows for replacing the control device with any flat surface, and it allows for examining the values of the parameters of the finger, and for performing actions in a video game, corresponding to the gestures, on their basis.

### THE ESSENCE OF THE INVENTION

The object of the invention is an application for controlling a video game, configured to receive information from a device comprising a touch layer, and data from an additional device for inputting data, and to control the progress of the game depending on this information and these data.

Preferably, the application is additionally configured to transmit data, in particular video data, to a display or to a device with a display, in which the display has the form of a monitor, a smart TV, a projector or a VR or AR device, the screen of a smartphone or the screen of a tablet, and/or to an external device, in particular the device for inputting data, in particular if the device for inputting data is a game controller, a gamepad, a joystick or a device wearable on the user's finger.

The invention also relates to a system for controlling a video game, comprising:
a first control device comprising a processor, memory and the application for controlling a video game according to the invention,
a device comprising a touch layer configured to determine the position of the user's finger on this touch layer and transmit the information about this position to the first control device,
an additional device for inputting data, configured to transmit the data to the first control device,
a display,
wherein the first control device is configured to receive said information from the device comprising a touch layer, and data from the additional device for inputting data, and to control the progress of the game depending on this information and these data, and to transmit the data, in particular video data, to the display,
wherein the display is configured to receive data, in particular video data, from the first control device, and to display a video image on their basis.

Preferably, the first control device, the device comprising a touch layer, and the display are a single integrated device, in particular a smartphone or a tablet.

Preferably, the device comprising a touch layer is a smartphone or a tablet, and the touch layer is the screen of the smartphone or the tablet.

Preferably, the first control device is a smartphone, a tablet, a smart TV or a video game console.

Preferably, the additional device for inputting data is a game controller, a gamepad, a joystick or a device wearable on the user's finger.

Preferably, the device comprising a touch layer is configured to transmit information about the position of the user's finger and/or the input and/or the data, and/or the triggered actions inputted by means of the finger on the touch layer directly to the first control device.

Preferably, the device comprising a touch layer is configured to transmit information about the position of the user's finger and/or the input and/or the data, and/or the triggered actions input by means of the finger on the touch layer to the first control device via the additional device for inputting data.

Preferably, the additional device for inputting data is configured to transmit the data directly to the first control device.

Preferably, the additional device for inputting data is configured to transmit the data to the first control device via the device comprising a touch layer.

Preferably, the display is configured to receive additional data, in particular video data, from an additional external source, for example a video game console, a smartphone, a tablet, or to receive video streaming from the internet, and to display a video image on their basis.

Preferably, the display has the form of a monitor, a smart TV, a projector or a VR or AR device, the screen of a smartphone or the screen of a tablet.

Preferably, the device comprising a touch layer and/or the additional device for inputting data and/or the first control device and/or the display are configured to communicate wirelessly, preferably via Bluetooth and/or Wi-Fi and/or near-field communication NFC and/or Li-Fi.

The object of the invention is also an application for generating virtual buttons, configured so as to display them over an application or a game.

Preferably, the virtual buttons have the form of a context menu, and it is configured to receive information from the device comprising a touch layer and possibly data from the additional device, and to generate data, in particular video data, in the form of a context menu dependent on this information and these data.

Preferably, the application is additionally configured in such a way that the virtual buttons can be assigned selected actions of the game or the physical buttons of game controllers, gamepads, mouse buttons or keyboard keys.

Preferably, the application is additionally configured to transmit information about the activated buttons to the display or the additional device for inputting data.

Preferably, the application is additionally configured to transmit data, in particular video data, to the display.

The object of the invention is also a system for displaying virtual buttons, comprising:
a second control device comprising a processor, memory and the application for generating virtual buttons according to the invention,
optionally, the system for controlling a video game according to the invention,
a device comprising a touch layer, configured to determine the position of the user's finger on this touch layer and transmit the information about this position to the second control device,
possibly, an additional device for inputting data, configured to transmit the data to the second control device,
a display,
wherein the second control device is configured to receive said information from the device comprising a touch layer and possibly data from the additional device, and to generate data, in particular video data, in the form of a context menu depending on this information and these data, and to transmit these data, in particular video data, to the display,
wherein the display is configured to receive data, in particular video data, from the second control device, and to display a video image on their basis.

Preferably, the context menu comprises any number of buttons, distributed over a circle around a place corresponding to the position of the user's finger determined by the device comprising a touch layer.

Preferably, said buttons are configured in such a manner that, following their activation, they transmit data to an external device, and in particular to the additional device for inputting data, and these data are transmitted to the second control device, in particular a tablet, a telephone or a television set, as information about pressing physical buttons corresponding to the selected buttons of a game controller or a keyboard and/or a mouse.

Preferably, the device comprising a touch layer is a smartphone or a tablet, and the touch layer is the screen of the smartphone or the tablet.

Preferably, the second control device is a smartphone, a tablet, a smart TV or a video game console.

Preferably, the additional device for inputting data is a game controller, a gamepad, a joystick or a device wearable on the user's finger.

Preferably, the display is configured to receive additional data, in particular video data, from an additional external source, for example a video game console, a smartphone, a tablet, or to receive video streaming from the internet, and to display a video image on their basis.

Preferably, the display has the form of a monitor, a smart TV, a projector or a VR or AR device, the screen of a smartphone or the screen of a tablet.

Preferably, the device comprising a touch layer and/or the additional device for inputting data and/or the second control device and/or the display are configured to communicate wirelessly, preferably via Bluetooth and/or Wi-Fi and/or near-field communication NFC and/or Li-Fi.

The invention also relates to a system for determining the value of at least one parameter of the user's finger, comprising:
a device wearable on the user's finger,
at least one sensor disposed in or on the device wearable on the user's finger,
a third control device comprising a processor, memory and a third control application,
optionally, the system for controlling a video game according to the invention,
optionally, the system for displaying virtual buttons according to the invention,
wherein said at least one sensor is adapted to transmit a signal to the third control device,
an arrangement for determining the value of at least one parameter of the user's finger, wherein said arrangement comprises at least one sensor, and it is configured to determine the value of at least one parameter of the user's finger, and to transmit information about the determined value of at least one parameter of the user's finger to the third control device,
wherein the third control device is configured to receive information about the determined value of at least one parameter of the user's finger.

Preferably, the sensor has the form of a motion sensor and/or a pressure sensor and/or an optical sensor and/or a proximity sensor.

Preferably, the system for determining the value of at least one parameter of the user's finger additionally comprises a navigation surface, in particular in the form of the touch screen of a smartphone or a tablet, or a touchpad or a trackpad.

Preferably, the navigation surface is configured to determine the value of at least one parameter of the user's finger, wherein the navigation surface is configured to transmit the value of at least one parameter of the user's finger to the third control device.

Preferably, the system for determining the value of at least one parameter of the user's finger is configured to determine the value of a parameter of the user's finger—meaning the angle between the distal phalanx and the proximal phalanx.

Preferably, the system for determining the value of at least one parameter of the user's finger is configured to determine the value of a parameter of the user's finger—meaning the pressure exerted by the finger on the sensor.

Preferably, the system for determining the value of at least one parameter of the user's finger is configured to determine the value of a parameter of the user's finger—meaning the pressure exerted by the finger on the navigation surface.

Preferably, the system for determining the value of at least one parameter of the user's finger additionally comprises a display.

Preferably, the display is a projector, a monitor, a smart TV, a VR or AR device, the screen of a smartphone or the screen of a tablet.

Preferably, the display is configured to receive data from the third control device, and to display an image on their basis.

Preferably, the display is configured to receive additional data, in particular video data, from an additional external source, for example a video game console, a smartphone, a tablet, or to receive video streaming from the internet, and to display a video image on their basis, including the image.

Preferably, the third control device is configured to perform actions based on the value of a parameter of the user's finger.

Preferably, the third control device is a tablet or a smartphone.

Preferably, the third control device is integrated with the display, and in particular the third control device is a smart TV.

Preferably, the third control device is a video game console.

Preferably, the device wearable on the user's finger has the form of a clip meant to be placed on the user's finger from the top or from a side, or of an open or closed ring with a sensor.

Preferably, the device wearable on the user's finger comprises a sensor adapted to measure the angle between the distal phalanx and the proximal phalanx of the user's finger.

Preferably, the device wearable on the user's finger comprises a motion sensor adapted to measure the difference in the position and the angle between the finger and the navigation surface, so as to measure the pressure exerted by the finger on the navigation surface.

Preferably, the device wearable on the user's finger comprises a pressure sensor and/or an optical sensor adapted to measure the pressure exerted by the finger on the navigation surface.

Preferably, the device wearable on the user's finger has an additional part extending over the distal phalanx of the finger, with a motion sensor located in the additional part.

Preferably, the device wearable on the user's finger comprises a button under the finger tip, in particular a pressure sensor, which is configured to generate and transmit a signal to the third control device when pressed.

Preferably, the third control device and/or the device wearable on the user's finger and/or the arrangement for determining the value of at least one parameter of the user's finger and/or the navigation surface and/or the display are configured to communicate wirelessly, preferably via Bluetooth and/or Wi-Fi and/or near-field communication NFC and/or Li-Fi.

Preferably, the system for determining the value of at least one parameter of the user's finger is configured in such a way that the user defines a portion of the surface of the touch layer in the form of the touch screen of a smartphone or a tablet, which constitutes the navigation surface.

The object of the invention is also a system for determining and presenting the position of the user's finger on a display, comprising:
a fourth control device configured to determine the position of the finger over the navigation surface, comprising a processor, memory and a fourth control application,
a navigation surface configured to transmit information about its position to the fourth control device,
a display,
optionally, the system for controlling a video game according to the invention,
optionally, the system for displaying virtual buttons according to the invention,
optionally, the system for determining the value of at least one parameter of the finger according to the invention,
an arrangement for determining the position of the user's finger over the navigation surface, wherein said arrangement comprises at least one sensor and it is configured to determine said position of the user's finger, and to transmit information about the determined position to the fourth control device,
wherein the fourth control device is configured to receive said information from the arrangement for determining the position of the user's finger, and to transmit data, in particular video data, to the display, wherein these data, and in particular video data, comprise a finger position indicator corresponding to the position of the user's finger over the navigation surface,
wherein the display is configured to receive data, in particular video data, from the fourth control device, and to display a video image on their basis, including the finger position indicator.

Preferably, the fourth control device is a tablet or a smartphone or a video game console.

Preferably, the fourth control device is integrated with the display, and in particular the fourth control device is a smart TV.

Preferably, the display has the form of a monitor, a smart TV, a projector or a VR or AR device, the screen of a smartphone or the screen of a tablet.

Preferably, the display is configured to receive additional data, in particular video data, from an additional external source, for example a video game console, a smartphone, a tablet, or to receive video streaming from the internet, and to display a video image on their basis, including the image.

Preferably, the navigation surface is the surface of a touch layer, in particular the touch screen of a tablet or a smartphone.

Preferably, the system for determining and presenting the position of the user's finger on a display is configured in such a way that the user defines a portion of the surface of the touch layer in the form of the touch screen of a smartphone or a tablet, which constitutes the navigation surface.

Preferably, the arrangement for determining the position of the user's finger over the navigation surface is adapted to be put on at least one of the user's fingers, wherein said arrangement comprises an accelerometer and/or a gyroscope, and it is configured to determine the position of the user's finger over the navigation surface in real time, using the data from said accelerometer and/or gyroscope.

Preferably, the arrangement for determining the position of the user's finger over the navigation surface additionally comprises an optical sensor configured to assist in determining the position of the user's finger over the navigation surface by determining the finger bend level via determining the angle between the distal phalanx and the proximal phalanx.

Preferably, the fourth control device and/or the arrangement for determining the position of the user's finger over the navigation surface, and/or the navigation surface and/or the display are configured to communicate wirelessly, preferably via Bluetooth and/or Wi-Fi and/or near-field communication NFC and/or Li-Fi.

Preferably, the system for determining and presenting the position of the user's finger on a display is configured to recognise the gestures performed by the user's finger over the navigation surface and/or on the navigation surface and/or in the form of a specific configuration of one or more of the user's fingers.

Preferably, the first control device and/or the second control device and/or the third control device and/or the fourth control device are the same device.

The system according to the invention assumes the combination of touch navigation known from mobile devices, such as a telephone or a tablet, with additional external input and feedback originating from one or more external devices worn on the finger, in order to create a controller, in particular, but not exclusively, for games, which combines the positive properties of touch navigation known from mobile games, such as a touch interface and precision of control, with additional input allowing for the performance of numerous actions at the same time, with no need to use several fingers, and with a feedback function, which allows for controlling the system, applications and games with no need to look at the fingers. The above, combined with virtual buttons displayed on a transparent layer over the game, and configured in such a way that, following activation, they would transmit information corresponding to the information about pressing physical buttons corresponding to the selected buttons of a game controller or a keyboard and/or a mouse, allows the players to use touch navigation for playing any games streamed from a cloud on any device, even when these games officially do not support touch navigation.

### SHORT DESCRIPTION OF THE DRAWINGS

The invention will now be presented in more detail in preferred embodiments, with reference to the attached drawing, in which:

FIGS. 1-3 present a system for determining the value of a parameter of the user's finger—meaning the angle between the distal phalanx and the proximal phalanx.

FIGS. 4-6 present a system for determining the value of a parameter of the user's finger—meaning the pressure exerted by the finger on the sensor,

FIGS. 7-11 present a system for determining and presenting the position of the user's finger on a display, configured in such a way that the user defines a portion of the surface of the touch layer,

FIGS. 12-13 present a device wearable on the user's finger in the form of a clip meant to be placed on the user's finger from the top or from a side, or of an open or closed ring with a sensor,

FIGS. 14-15 present a device wearable on the user's finger comprising a sensor adapted to measure the angle between the distal phalanx and the proximal phalanx of the user's finger,

FIGS. 17-19 present a device wearable on the user's finger having an additional part extending over the distal phalanx of the finger, with a motion sensor located in the additional part.

### DETAILED DESCRIPTION OF PREFERRED EMBODIMENTS OF THE INVENTION

In one of the preferable embodiments, the present invention has the form of a system for controlling a video game. The system comprises a first control device, which comprises a processor, memory and an application for controlling a video game. The application for controlling a video game is configured to receive information from a device comprising a touch layer, and data from an additional device for inputting data, and to control the progress of the game depending on this information and these data. Preferably, the application for controlling a video game is additionally configured to transmit data, in particular video data, to a display or to a device with a display, in which the display has the form of a monitor, a smart TV, a projector or a VR or AR device, the screen of a smartphone or the screen of a tablet, and/or to an external device, in particular the device for inputting data, in particular if the device for inputting data is a game controller, a gamepad, a joystick or a device wearable on the user's finger. The system further comprises a device comprising a touch layer configured to determine the position of the user's finger on this touch layer and transmit the information about this position to the first control device. The system also has the additional device for inputting data, configured to transmit the data to the first control device, and the display. The first control device is configured to receive said information from the device comprising a touch layer, and data from the additional device for inputting data, and to control the progress of the game depending on this information and these data, and to transmit the data, in particular video data, to the display. The display is in turn configured to receive the data, in particular video data, from the first control device, and to display a video image on their basis.

Preferably, the device comprising a touch layer is a smartphone or a tablet, and the touch layer is the screen of the smartphone or the tablet.

The first control device is a smartphone, a tablet, a smart TV or a video game console. The additional device for inputting data may be a game controller, a gamepad, a joystick or a device wearable on the user's finger.

The device comprising a touch layer is configured to transmit information about the position of the user's finger and/or the input and/or the data, and/or the triggered actions inputted by means of the finger on the touch layer directly to the first control device.

Preferably, the device comprising a touch layer is configured to transmit information about the position of the user's finger on the touch layer to the first control device via the additional device for inputting data. The additional device for inputting data is configured to transmit the data directly to the first control device.

According to another preferable embodiment, the additional device for inputting data is configured to transmit the data to the first control device via the device comprising a touch layer.

Preferably, the display is configured to receive additional data, in particular video data, from an additional external source, for example a video game console, a smartphone, a tablet, or to receive video streaming from the internet, and to display a video image on their basis.

Preferably, the display may have the form of a monitor, a smart TV, a projector or a VR or AR device, the screen of a smartphone or the screen of a tablet.

The device comprising a touch layer and/or the additional device for inputting data and/or the first control device and/or the display are configured to communicate wirelessly, preferably via Bluetooth and/or Wi-Fi and/or near-field communication NFC and/or Li-Fi.

According to a further embodiment, the invention has the form of a system for displaying virtual buttons in the form of a context menu, comprising a second control device comprising a processor, memory and an application for generating virtual buttons. An application for generating data, in particular video data, in the form of a context menu, is configured so as to display them over an application or a game. The virtual buttons have the form of a context menu, and it is configured to receive information from the device comprising a touch layer and possibly data from the additional device, and to generate data, in particular video data, in the form of a context menu dependent on this information and these data.

The application is additionally configured in such a way that the virtual buttons can be assigned selected actions of the game or the physical buttons of game controllers, gamepads, mouse buttons or keyboard keys. The application may also be configured to transmit information about the activated buttons to the display or the additional device for inputting data, and to transmit data, in particular video data, to the display. The system further comprises the device comprising a touch layer, configured to determine the position of the user's finger on this touch layer and transmit the information about this position to the second control device. The system may possibly comprise the additional device for inputting data, configured to transmit the data to the second control device. The system also has the display in which e.g. virtual buttons in the form of a context menu are displayed. The second control device is configured to receive said information from the device comprising a touch layer and possibly data from the additional device, and to generate data, in particular video data, in the form of a context menu that is dependent on this information and these data, and to transmit these data, in particular video data, to the display. The display is configured to receive data, in particular video data, from the second control device, and to display a video image on their basis.

In addition, the system may comprise the system for controlling a video game comprising the first control device, which comprises a processor, memory and an application for controlling a video game. The application for controlling a video game is configured to receive information from the device comprising a touch layer, and data from the additional device for inputting data, and to control the progress of the game depending on this information and these data. Preferably, the application for controlling a video game is additionally configured to transmit data, in particular video data, to the display. Due to this, the system further comprises the device comprising a touch layer configured to determine the position of the user's finger on this touch layer and transmit the information about this position to the first control device. The system also has the additional device for inputting data, configured to transmit the data to the first control device, and the display. The first control device is configured to receive said information from the device comprising a touch layer, and data from the additional device for inputting data, and to control the progress of the game depending on this information and these data, and to transmit the data, in particular video data, to the display. The display is in turn configured to receive the data, in particular video data, from the first control device, and to display a video image on their basis.

Preferably, the context menu comprises any number of buttons, preferably four buttons, distributed over a circle around a place corresponding to the position of the user's finger determined by the device comprising a touch layer. Due to the above, the user may select a proper command from the context menu, depending on the needs or on the situation in the game. Preferably, the appearance and functions of said buttons correspond to the physical buttons of a standard game controller. The standard game controller is usually a pad or a joystick. The buttons are configured in such a manner that, following activation, they transmit data to an external device, and in particular to the additional device for inputting data, and these data are transmitted to the second control device, in particular a tablet, a telephone or a television set, as information about pressing physical buttons corresponding to selected buttons of a game controller or a keyboard and/or a mouse.

The device comprising a touch layer is a smartphone or a tablet, and the touch layer is the screen of the smartphone or the tablet. The second control device may be a smartphone, a tablet, a smart TV or a video game console.

Preferably, the additional device for inputting data is a game controller, a gamepad, a joystick or a device wearable on the user's finger.

Preferably, the display is configured to receive additional data, in particular video data, from an additional external source, for example a video game console, a smartphone, a tablet, or to receive video streaming from the internet, and to display a video image on their basis.

Preferably, the display has the form of a monitor, a smart TV, a projector or a VR or AR device, the screen of a smartphone or the screen of a tablet.

Preferably, the device comprising a touch layer and/or the additional device for inputting data and/or the second control device and/or the display are configured to communicate wirelessly, preferably via Bluetooth and/or Wi-Fi and/or near-field communication NFC and/or Li-Fi.

Due to the use of the system for displaying virtual buttons, the virtual buttons displayed in any place of the interface or in the form of a menu displayed within the range of one of the user's fingers touching the screen, on a transparent layer over a game or an application, in particular a game streaming application, which upon activation transmit information about the input not in the form of performing an action, but in the form of information about the pressing of a button corresponding to any button on a traditional controller, in such a manner that the game or application performs an action assigned to a physical button of a game controller, or another form of traditional navigation, e.g. a keyboard.

The purpose of the context menu is to add a larger amount of additional input for performing side actions. The context menu may have the form of a menu displayed on the interface in the location of the finger. The finger is located by the place in which the finger touches the navigation surface, or by feedback functions.

### Activation of the Menu

a. The menu may be activated with one of the buttons of the device wearable on the user's finger,
b. The menu may be activated by pressing a button on the interface of a game or an application,
c. The menu may be activated by an external mechanical button, which mechanically presses the button on the interface of a game or an application. Preferably, these may be triggers which, after being put on a phone, when pressed by a finger, mechanically touch the screen in the place where there is a button on the interface,
d. The menu may be activated with a gesture.

The context menu may be displayed on the screen of the navigation space and/or only on an external screen. The menu is displayed within the range of one of the fingers, e.g. around a given finger (the place of touching the navigation space, or a place in the space above which the finger is located). This may be the same finger which activates the menu, as well as another finger. E.g. one of the buttons on the finger tip of the left thumb activates the menu around the right finger.

The context menu may have one or more buttons, which correspond to the actions assigned to the buttons of traditional controllers. In this case, the buttons of a traditional controller are assigned to the menu, and the game/application performs an action which was previously assigned in the configuration of the traditional controller. The context menu may also have one or more buttons which correspond to the actions assigned in the game/application.

The application displaying virtual buttons in the form of a context menu communicates back with the controllers which, after receiving information about the selected position from the context menu, transmit information about the input, meaning about the button which was pressed, to the device. For example, the main buttons and the side actions from the context menu may be assigned to specific buttons of a traditional controller supported by a game or an application. In such a case, upon receiving information about the selection of an action in the input menu, the controller returns information about input corresponding to, e.g. pressing button A on the controller. An alternative solution assumes using a motion sensor, which will recognise the direction of movement towards the button/action displayed in the menu which is being approached by the finger. In such a situation, the data about the type of the transmitted input, e.g. buttons A or B, are transmitted directly by the controller, with no need to receive the data from the application in advance. The context menu displayed in the application or on an external screen becomes only a form of visual feedback information when making the selection.

Activation of the context menu proceeds by touching/pressing the selected button, or by swiping the finger and releasing it in the location of the button.

The context menu may take on any form which arranges the action icons within a short distance from the finger with which the user may choose the actions. The simplest example is the form of a circle, divided into any number of parts. Wherein the form of a context menu with multiple levels is possible, in which the selection of one of the buttons of the context menu displays the next level of the context menu with additional actions.

An interface with virtual buttons on a transparent layer over a game or an application allows for configuring virtual buttons in such a way in which they would correspond to the actions in the game, or cause input corresponding to any buttons of popular game controllers, game pads, mouse buttons or keyboard keys.

The solution is in particular intended to use game-supported navigation using game controllers, keyboards and mouses, in order to generate on their basis virtual navigation which provides the ability to play games streamed from a cloud, which do not have native touch navigation, on devices with a touch screen.

The use of a system with a context menu makes it possible to play games streamed from a cloud which do not have native touch navigation, but only traditional navigation supporting game controllers, a keyboard and a mouse, on devices with a touch layer.

The system for displaying data, in particular video data, in the form of a context menu, is within the range of one of the user's fingers which touches the touch layer, which allows for selecting any/each action of this menu only by moving the finger, with no significant hand movements.

Preferably, the system for displaying data, in particular video data, in the form of a context menu is placed around one of the fingers, which touches the touch layer.

According to another preferable embodiment of the invention, the selection of actions from the context menu takes place by swiping and releasing the finger over the selected button, and by releasing the finger, without withdrawing the finger from the moment when the menu appears on the touch layer.

The context menu may be activated in an external application, which is activated over another application, and in particular a game or a game streaming application. The context menu may also be activated in a game streaming application, over a layer with the streamed image of the game. It may also be displayed on a layer over a game or an application/the graphical layer of the game or the application.

Preferably, the activation of a virtual button of the context menu is assigned in the application code to triggering an action indirectly by the button of a game controller or a keyboard and/or a mouse assigned thereto.

Preferably, the information about input from the context menu received by an external device is transmitted further to another device, e.g. a smart TV, or back to the device from which it was received, e.g. a telephone.

Preferably, the information about the button selected from the context menu is transmitted to an external device, and in particular to the additional device for inputting data, and returned to the control device, in particular a tablet, a telephone or a television set, as information about pressing a physical button/physical input corresponding to the buttons of a game controller or a keyboard and/or a mouse.

The purpose of adding external input is the ability to perform several actions at the same time during the game, with no need to use additional fingers. The solution is intended to improve the ergonomics, efficiency, comfort and experience of playing more complex mobile titles, as well as to enable playing console and PC titles using touch navigation, including, but not exclusively, via cloud gaming.

Yet another aspect of the invention constitutes a system for determining the value of at least one parameter of the user's finger, comprising a device wearable on the user's finger, at least one sensor disposed in or on the device wearable on the user's finger, a third control device comprising a processor, memory and a third control application. The at least one sensor is adapted to transmit a signal to the third control device. The system additionally comprises an arrangement for determining the value of at least one parameter of the user's finger, wherein said arrangement comprises at least one sensor, and it is configured to determine the value of at least one parameter of the user's finger, and to transmit information about the determined value of at least one parameter of the user's finger to the third control device. The third control device is configured to receive information about the determined value of at least one parameter of the user's finger.

In addition, the system for determining the value of at least one parameter of the user's finger may comprise a system for controlling a video game, comprising a first control device, which comprises a processor, memory and an application for controlling a video game. The application for controlling a video game is configured to receive information from a device comprising a touch layer, and data from an additional device for inputting data, and to control the progress of the game depending on this information and these data. Preferably, the application for controlling a video game is additionally configured to transmit data, in particular video data, to a display. Due to this, the system further comprises the device comprising a touch layer configured to determine the position of the user's finger on this touch layer and transmit the information about this position to the first control device. The system also has the additional device for inputting data, configured to transmit the data to the first control device, and the display. The first control device is configured to receive said information from the device comprising a touch layer, and data from the additional device for inputting data, and to control the progress of the game depending on this information and these data, and to transmit the data, in particular video data, to the display. The display is in turn configured to receive the data, in particular video data, from the first control device, and to display a video image on their basis.

In addition, the system for determining the value of at least one parameter of the user's finger may comprise a system for displaying virtual buttons comprising a second control device comprising a processor, memory and an application for the context menu, comprising a second control device comprising a processor, memory and an application for generating virtual buttons. An application for generating data, in particular video data, in the form of a context menu, is configured so as to display them over an application or a game. The virtual buttons have the form of a context menu, and it is configured to receive information from the device comprising a touch layer and possibly data from the additional device, and to generate data, in particular video data, in the form of a context menu dependent on this information and these data. The application is additionally configured in such a way that the virtual buttons can be assigned selected actions of the game or the physical buttons of game controllers, gamepads, mouse buttons or keyboard keys. The application may also be configured to transmit information about the activated buttons to the display or the additional device for inputting data, and to transmit data, in particular video data, to the display. The system further comprises the device comprising a touch layer, configured to determine the position of the user's finger on this touch layer and transmit the information about this position to the second control device. The system may possibly comprise the additional device for inputting data, configured to transmit the data to the second control device. The system also has the display which displays, e.g. the context menu. The second control device is configured to receive said information from the device comprising a touch layer and possibly data from the additional device, and to generate data, in particular video data, in the form of a context menu depending on this information and these data, and to transmit these data, in particular video data, to the display. The display is configured to receive data, in particular video data, from the second control device, and to display a video image on their basis.

At least one sensor may contact the surface of the finger.

Preferably, the sensor has the form of a camera and/or a proximity sensor and/or a motion sensor and/or a pressure sensor and/or an optical sensor.

The system for determining the value of at least one parameter of the user's finger may additionally comprise a navigation surface, in particular in the form of a touch layer, in particular in the form of the touch screen of a smartphone or a tablet, or a touchpad or a trackpad, configured to determine the value of at least one parameter of the user's finger, the navigation surface being configured to transmit the value of at least one parameter of the user's finger to the third control device.

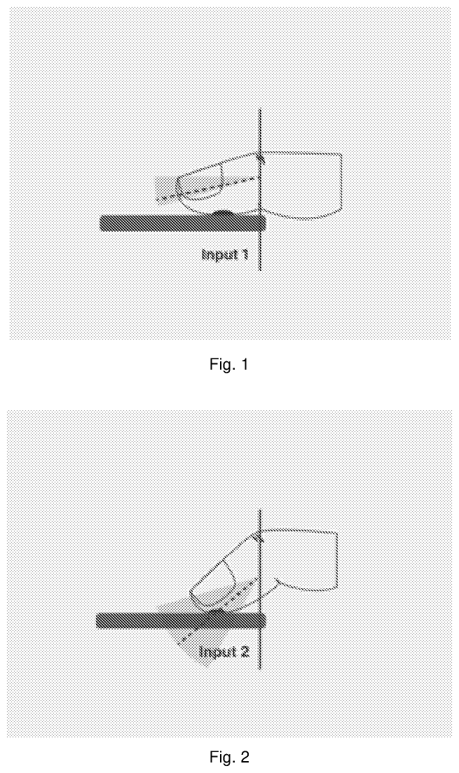

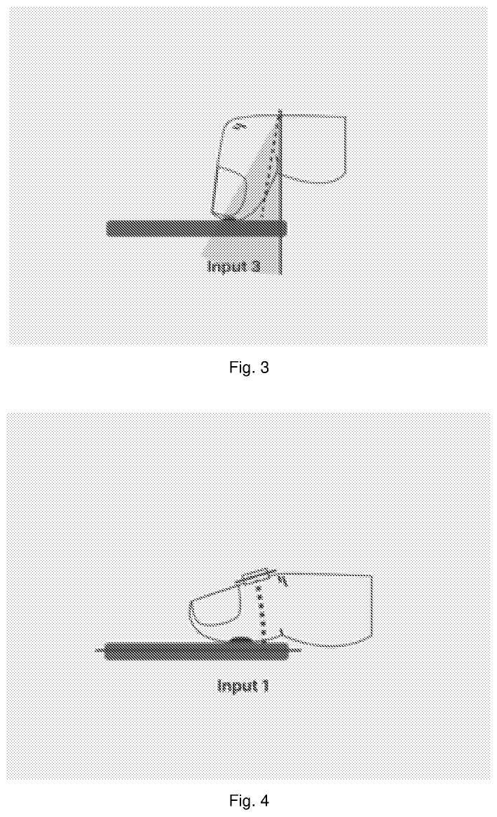

Preferably, the system for determining the value of at least one parameter of the user's finger is configured to determine the value of a parameter of the user's finger—meaning the angle between the distal phalanx and the proximal phalanx, which is presented in FIGS. 1-3.

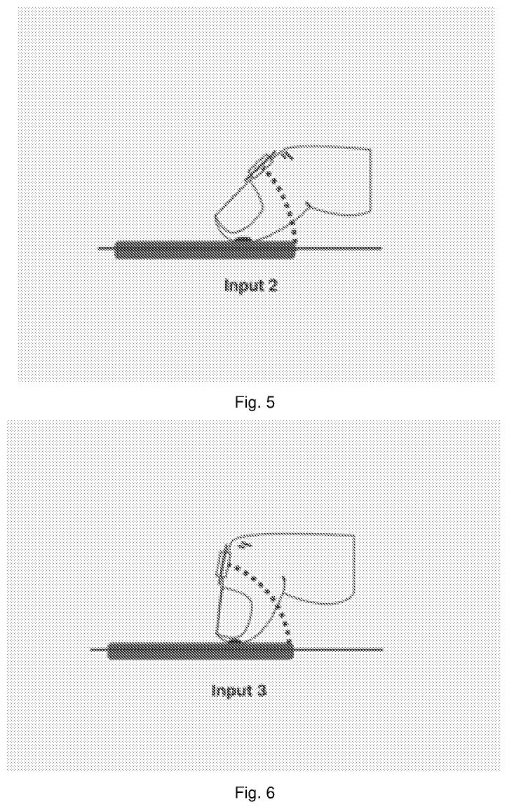

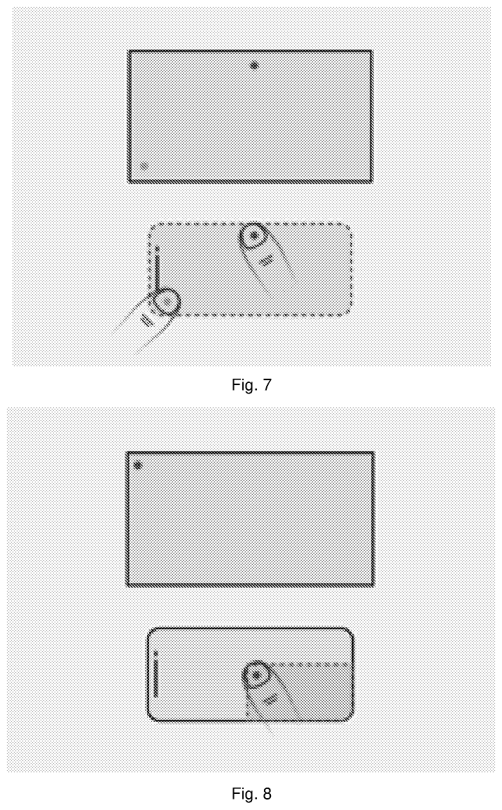

Preferably, the system for determining the value of at least one parameter of the user's finger is configured to determine the value of a parameter of the user's finger—meaning the pressure exerted by the finger on the sensor, which is presented in FIGS. 4-6.

Preferably, the system for determining the value of at least one parameter of the user's finger is configured to determine the value of a parameter of the user's finger—meaning the pressure exerted by the finger on the navigation surface and/or the angle between the distal phalanx and the proximal phalanx. In this case, information about the parameter is collected when touching the navigation surface with the finger, preferably through the value of the pressure exerted by the finger on the navigation surface.

The system for determining the value of at least one parameter of the user's finger additionally comprises a display. The display may be a projector, a monitor, a smart TV, a VR or AR device, the screen of a smartphone or the screen of a tablet. The display is configured to receive data from the third control device and to display an image on their basis.

Preferably, the display is configured to receive additional data, in particular video data, from an additional external source, for example a video game console, a smartphone, a tablet, or to receive video streaming from the internet, and to display a video image on their basis, including the image acquired based on the data received from the third control device.

Preferably, the third control device is configured to perform actions based on the value of a parameter of the user's finger.

The third control device may be a tablet or a smartphone. Furthermore, the third control device may be integrated with the display, and in particular the third control device is a smart TV. Preferably, the third control device is a video game console.

Preferably, the device wearable on the user's finger has the form of a clip meant to be placed on the user's finger from the top or from a side, or of an open or closed ring with a sensor, which is presented in FIGS. 12 and 13. A ring with only a sensor (e.g., but not exclusively, an EMG) receiving a change in the tension of finger muscles or tissue. The pressing of the finger can be detected, and the input can be read due to the information about changes in the tension, and the finger bend angle, meaning the type of input, can be identified due to the information about the tension of the finger. This ring may be supplemented with an additional sensor, e.g. a Camera/Proximity Sensor/Infrared sensor, which will help to assess the bending of the finger.

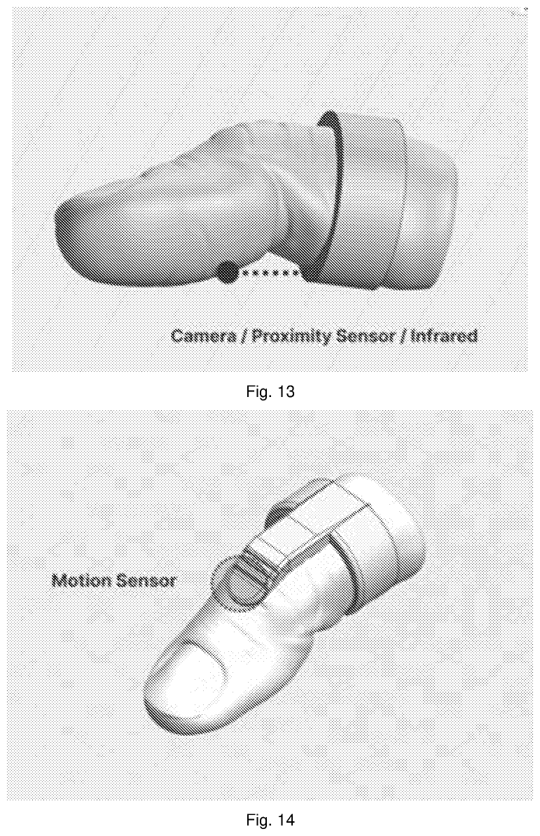

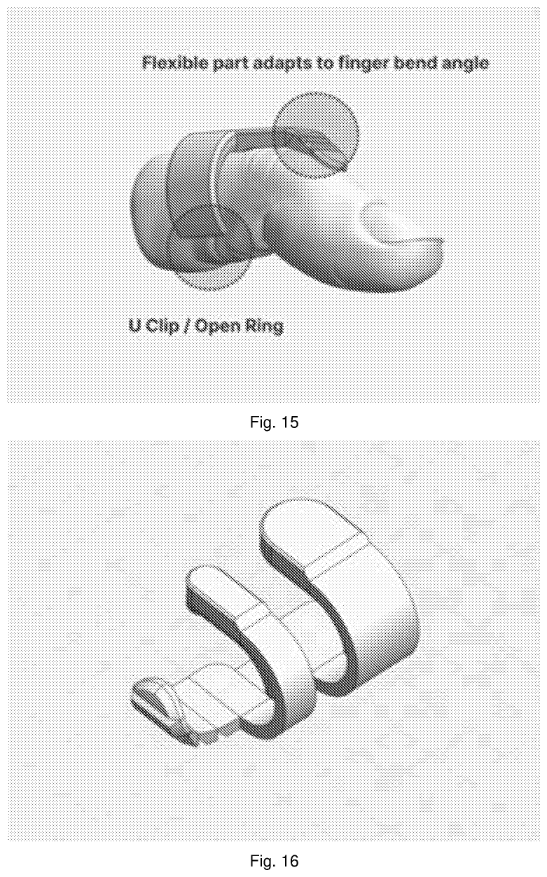

Preferably, the device wearable on the user's finger comprises a sensor adapted to measure the angle between the distal phalanx and the proximal phalanx of the user's finger, which is presented in FIGS. 14 and 15. Preferably, the additional element extends from the top, and it is made of a flexible material, e.g. rubber, in such a manner that it always presses against the top part of the distal phalanx of the finger. There may be more fastening methods. This could just as well extend from a side or from the bottom. An important feature is that the motion sensor should abut on the distal phalanx and move along with it during bending.

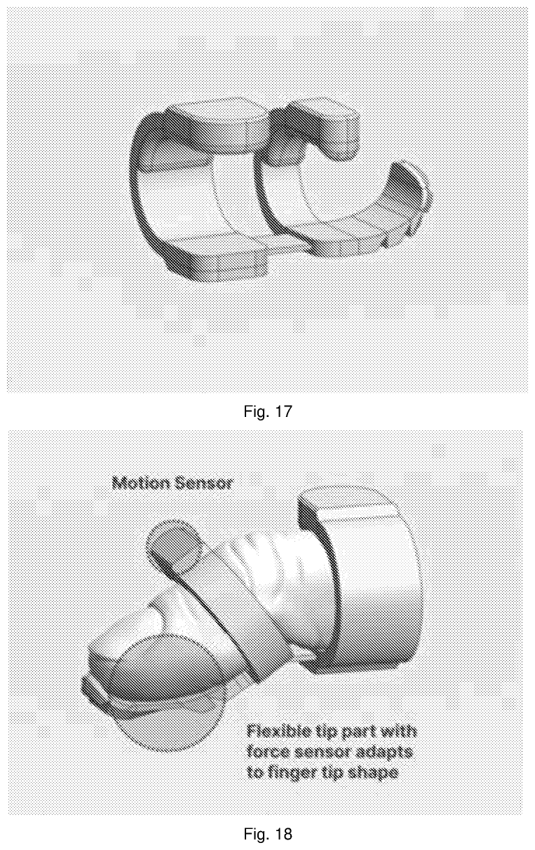

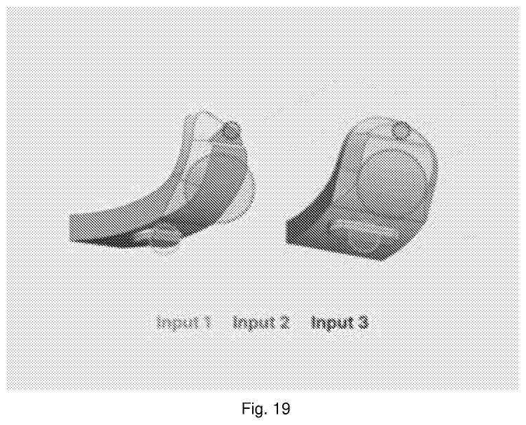

Preferably, the device wearable on the user's finger has an additional part extending over the distal phalanx of the finger, with a motion sensor located in the additional part, which is presented in FIGS. 16-19. Although the structure has a completely different visual appearance, this solution may be derived from the solution presented in FIGS. 14 and 15. The solution has the form of a clip or an open ring, in this case put on from the side. The motion sensor is still placed on the distal phalanx of the finger, and it serves the same function. The “fingertip button” element under the fingertip is an addition which generates input when pressed.

Preferably, the device wearable on the user's finger may comprise a button under the fingertip, in particular a pressure sensor, which is configured to generate and transmit a signal to the third control device when pressed.

In another embodiment, the device wearable on the user's finger comprises a pressure sensor and/or an optical sensor adapted to measure the pressure exerted by the finger on the navigation surface.

Preferably, the device wearable on the user's finger may have an additional part extending over the distal phalanx of the finger, with a motion sensor located in the additional part.

Preferably, the device wearable on the user's finger comprises a button under the fingertip, in particular a pressure sensor, which is configured to generate and transmit a signal to the third control device when pressed.

Preferably, the third control device and/or the device wearable on the user's finger and/or the arrangement for determining the value of at least one parameter of the user's finger and/or the navigation surface and/or the display are configured to communicate wirelessly, preferably via Bluetooth and/or Wi-Fi and/or near-field communication NFC and/or Li-Fi.

Preferably, the system for determining the value of at least one parameter of the user's finger is configured in such a way that the user defines a portion of the surface of the touch layer in the form of the touch screen of a smartphone or a tablet, which constitutes a navigation surface, in particular in the form of a touch layer, in particular in the form of the touch screen of a smartphone or a tablet, or a touchpad or a trackpad, configured to determine the value of at least one parameter of the user's finger, the navigation surface being configured to transmit the value of at least one parameter of the user's finger to the third control device.

Another aspect of the invention is a system for determining and presenting the position of the user's finger on a display, comprising a fourth control device configured to determine the position of the finger over the navigation surface, comprising a processor, memory and a fourth control application, a navigation surface configured to transmit information about its position to the fourth control device, and a display. The system for determining and presenting the position of the user's finger also comprises an arrangement for determining the position of the user's finger over the navigation surface, wherein said arrangement comprises at least one sensor and it is configured to determine said position of the user's finger and to transmit information about the determined position to the fourth control device. The fourth control device is configured to receive said information from the arrangement for determining the position of the user's finger, and to transmit data, in particular video data, to the display, wherein these video data comprise a finger position indicator corresponding to the position of the user's finger over the navigation surface. The display is configured to receive data, in particular video data, from the fourth control device, and to display a video image on their basis, including the finger position indicator.

The system for determining and presenting the position of the user's finger on a display may also comprise a system for controlling a video game, comprising a first control device, which comprises a processor, memory and an application for controlling a video game. The application for controlling a video game is configured to receive information from a device comprising a touch layer, and data from an additional device for inputting data, and to control the progress of the game depending on this information and these data. Preferably, the application for controlling a video game is additionally configured to transmit data, in particular video data, to the display. Due to this, the system further comprises the device comprising a touch layer configured to determine the position of the user's finger on this touch layer and transmit the information about this position to the first control device. The system also has the additional device for inputting data, configured to transmit the data to the first control device, and the display. The first control device is configured to receive said information from the device comprising a touch layer, and data from the additional device for inputting data, and to control the progress of the game depending on this information and these data, and to transmit the data, in particular video data, to the display. The display is in turn configured to receive the data, in particular video data, from the first control device, and to display a video image on their basis.

In addition, the system for determining and presenting the position of the user's finger on a display may comprise a system for displaying virtual buttons, comprising a second control device comprising a processor, memory and an application for generating virtual buttons. An application for generating data, in particular video data, in the form of a context menu, is configured so as to display them over an application or a game. The virtual buttons have the form of a context menu, and it is configured to receive information from the device comprising a touch layer and possibly data from the additional device, and to generate data, in particular video data, in the form of a context menu dependent on this information and these data. The application is additionally configured in such a way that the virtual buttons can be assigned selected actions of the game or the physical buttons of game controllers, gamepads, mouse buttons or keyboard keys. The application may also be configured to transmit information about the activated buttons to the display or the additional device for inputting data, and to transmit data, in particular video data, to the display. The system further comprises the device comprising a touch layer, configured to determine the position of the user's finger on this touch layer and transmit the information about this position to the second control device. The system may possibly comprise the additional device for inputting data, configured to transmit the data to the second control device. The system also has the display which displays, e.g. the context menu. The second control device is configured to receive said information from the device comprising a touch layer and possibly data from the additional device, and to generate data, in particular video data, in the form of a context menu depending on this information and these data, and to transmit these data, in particular video data, to the display. The display is configured to receive data, in particular video data, from the second control device, and to display a video image on their basis.

In addition, the system for determining and presenting the position of the user's finger on a display may also comprise a system for determining the value of at least one parameter of the user's finger comprising a device wearable on the user's finger, at least one sensor disposed in or on the device wearable on the user's finger, a third control device comprising a processor, memory and a third control application. The at least one sensor is adapted to transmit a signal to the third control device. The system additionally comprises an arrangement for determining the value of at least one parameter of the user's finger, wherein said arrangement comprises at least one sensor, and it is configured to determine the value of at least one parameter of the user's finger, and to transmit information about the determined value of at least one parameter of the user's finger to the third control device. The third control device is configured to receive information about the determined value of at least one parameter of the user's finger.

The fourth control device may be a tablet or a smartphone or a video game console. The fourth control device is integrated with the display, and in particular the fourth control device is a smart TV.

The display may have the form of a monitor, a smart TV, a projector or a VR or AR device, the screen of a smartphone or the screen of a tablet. The display is configured to receive additional data, in particular video data, from an additional external source, for example a video game console, a smartphone, a tablet, or to receive video streaming from the internet, and to display a video image on their basis, including the image.

Preferably, the navigation surface of the system for determining and presenting the position of the user's finger on a display is the surface of the touch layer, in particular the touch screen of a tablet or a smartphone.

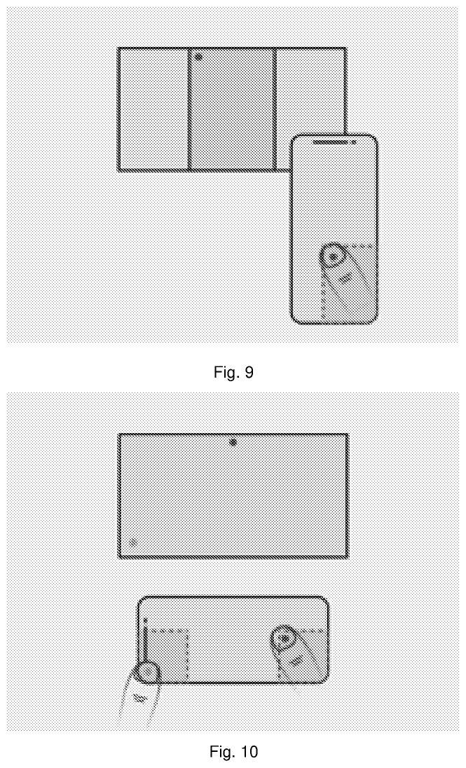

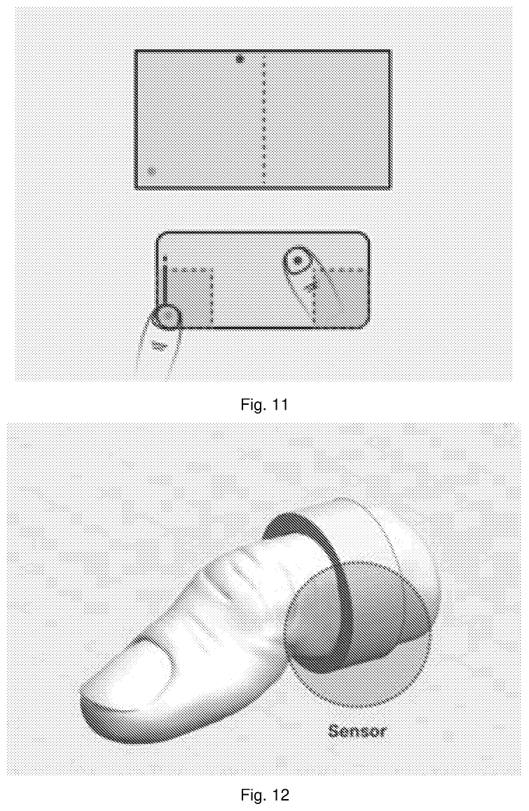

Preferably, the system for determining and presenting the position of the user's finger on a display is configured in such a way that the user defines a portion of the surface of the touch layer in the form of the touch screen of a smartphone or a tablet, which constitutes the navigation surface, which is presented in FIGS. 7-11.

Preferably, the arrangement for determining the position of the user's finger over the navigation surface is adapted to be put on at least one of the user's fingers, wherein said arrangement comprises an accelerometer and/or a gyroscope, and it is configured to determine the position of the user's finger over the navigation surface in real time, using the data from said accelerometer and/or gyroscope.

In yet another embodiment of the invention, the arrangement for determining the position of the user's finger over the navigation surface is adapted to be put on at least one of the user's fingers, wherein said arrangement comprises a magnetometer, and it is configured to determine the position of the user's finger over the navigation surface in real time, using the data from the magnetometer.

In another embodiment of the invention, the arrangement for determining the position of the user's finger over the navigation surface comprises at least one camera, and it is configured to determine the position of the user's finger over the navigation surface in real time, using the data from the at least one camera, wherein preferably said arrangement comprises a device wearable on at least one of the user's fingers, having an indicator.

According to yet another aspect of the invention, the arrangement for determining the position of the user's finger over the navigation surface comprises a device configured to detect the intensity of light, and configured to determine the position of the user's finger over the navigation surface in real time, using the data from said device, wherein preferably said arrangement comprises a device wearable on at least one of the user's fingers, which constitutes a light barrier or a reflector for the light emitted by the navigation surface.

Preferably, the arrangement for determining the position of the user's finger over the navigation surface additionally comprises an optical sensor configured to assist in determining the position of the user's finger over the navigation surface by determining the finger bend level via determining the angle between the distal phalanx and the proximal phalanx.

Preferably, the fourth control device and/or the arrangement for determining the position of the user's finger over the navigation surface, and/or the navigation surface and/or the display are configured to communicate wirelessly, preferably via Bluetooth and/or Wi-Fi and/or near-field communication NFC and/or Li-Fi.

Preferably, the system for determining and presenting the position of the user's finger on a display is configured to recognise the gestures performed by the user's finger over the navigation surface and/or on the navigation surface and/or in the form of a specific configuration of one or more of the user's fingers.

According to another embodiment of the invention, the first control device and/or the second control device and/or the third control device and/or the fourth control device are the same device.

Each of the systems according to the present invention, i.e. the system for dual control of a game, the system for displaying virtual buttons, the system for determining the value of at least one parameter of the user's finger and the system for determining and presenting the position of the user's finger on a display, may be implemented individually, as the only system, without the implementation of the remaining systems, or any two of them may be implemented, i.e. the system for dual control of a game and the system for displaying data, in particular video data, in the form of a context menu, or the system for dual control of a game and the system for determining the value of at least one parameter of the user's finger, or the system for dual control of a game and the system for determining and presenting the position of the user's finger on a display, or the system for displaying data, in particular video data, in the form of a context menu and the system for determining the value of at least one parameter of the user's finger, or the system for displaying data, in particular video data, in the form of a context menu and the system for determining and presenting the position of the user's finger on a display, or the system for determining the value of at least one parameter of the user's finger and the system for determining and presenting the position of the user's finger on a display.

It is also possible to implement three of the abovementioned systems, i.e. the system for dual control of a game and the system for displaying data, in particular video data, in the form of a context menu and the system for determining the value of at least one parameter of the user's finger, or the system for displaying data, in particular video data, in the form of a context menu and the system for determining the value of at least one parameter of the user's finger and the system for determining and presenting the position of the user's finger, or the system for dual control of a game and the system for displaying data, in particular video data, in the form of a context menu and the system for determining and presenting the position of the user's finger on a display, or the system for dual control of a game and the system for determining the value of at least one parameter of the user's finger and the system for determining and presenting the position of the user's finger on a display.

It is also possible to implement all of the four abovementioned systems at the same time, i.e. the system for dual control of a game and the system for displaying data, in particular video data, in the form of a context menu and the system for determining the value of at least one parameter of the user's finger and the system for determining and presenting the position of the user's finger on a display.

As used in the present invention, an application is a computer program which, when activated on proper hardware, will perform the actions mentioned in the present specification. They refer to a computer program product comprising instructions which, when the program is executed by the computer, cause the computer to perform proper actions. In the light of the present invention, the above explanation of what an application is refers to all the applications mentioned in the specification, i.e. for dual control of a game, for displaying a context menu, and for displaying the third and the fourth application.

In a sample use of the system according to the invention, touch navigation takes place in contact with a navigation surface, in particular touch-sensitive, in particular a telephone or a tablet, but this may also be a different surface covered with any touch sensor, or a surface which is not touch-sensitive. The purpose of the navigation surface is to return the information about the position of the user's finger and/or the input and/or the data and/or the triggered actions inputted by means of the finger. When the surface is touch-sensitive, this takes place analogically to the operation of touch screens in mobile devices or trackpads. For a surface which is not touch-sensitive, this takes place on the basis of measurements of the system sensors. The purpose of the navigation surface is to serve a function analogical to touch control in mobile games, or a mouse in a computer, or analogue knobs in traditional pads. The player need not withdraw any of the thumbs and touch the virtual buttons in order to trigger targeting or shooting actions. They may still move their character by using the left thumb, and rotate the camera by using the right thumb. At the same time, slightly stronger pressing of the left thumb will trigger the targeting actions, and slightly stronger pressing of the right thumb will trigger the shooting actions.

A sample use may be such that the user puts on two devices wearable on the user's finger, one per the thumb of each hand, and plays a “first person shooter”-type mobile game on a telephone. Basic control takes place by means of the native capabilities of the telephone and the functions of the game—the left thumb is used to move the character by means of a virtual knob; the right thumb is used to rotate the camera by means of swiping the finger against the right part of the screen. They may also freely use the actions assigned to virtual buttons placed on an interface in the form of a context menu. At the same time, they may use additional input, which is allowed by the device wearable on the user's finger.

Another use may be such that the user plays a “first person shooter”-type game, which is streamed from a cloud to a television set. They use a telephone and two devices wearable on the user's finger, each one worn on the thumb of each hand. A set consisting of these three devices and an application installed on the telephone constitutes the entire controller. The player controls the movement of the character and the rotation of cameras in the application on the telephone, which transmits information about the tilt of the virtual knob and the movement of the finger against the screen directly to the television set, or to the device wearable on the user's finger, which transmits it further to the television set along with additional input made by the player via the device wearable on the user's finger. Controlling a game streamed to a television set requires a larger number of actions than just moving the character and rotating the camera. Due to external main actions, the player may additionally perform other necessary actions, such as targeting and shooting.

Main external input involves pressing the finger against the navigation plane. Several separate inputs can be, but do not have to be distinguished depending on the angle at which the finger, and in particular the distal phalanx, has been pressed against the navigation plane, or depending on the specific part of the fingertip which is pressed against the navigation plane. Additional external input involves choosing an action from the context menu. The menu is displayed on the screen of the navigation surface and/or on an external screen, preferably in a place which corresponds to the position of one of the fingers. The selection of a position from the context menu involves swiping the finger or the pointer displayed on the external screen, by means of the finger, towards the selected element, and releasing it when the element has been selected, or normally pressing the selected element. The external spatial input involves the performance of specific gestures in the space with one or more fingers wearing the device wearable on the user's finger. The gestures may be performed without reference to another object in the space, and/or with respect to the navigation surface and/or the second or more devices wearable on the user's finger. The purpose of the external input is the ability to perform a larger number of actions at the same time, without interrupting other actions, with a single finger, e.g. to allow for using screen touch or a control plane in order to control the pointer analogically to a mouse pointer. When touching the screen or the control plane with a finger and swiping it against the same, we control the pointer displayed on the external screen; at the same time, we may press the finger harder, in order to cause a click.

The purpose of adding external input is the ability to perform several actions at the same time during the game, with no need to use additional fingers. The solution is also aimed at improving the ergonomics, efficiency, comfort and experience of playing, e.g. so that the player touching the screen with their right thumb in order to rotate the camera could start shooting without resigning from rotation of the camera even for a split second.

Feedback involves collecting data from the motion sensor in order to acquire feedback information about the position of the fingers with respect to the navigation surface, and in particular over the telephone or tablet, but also over another external navigation plane, e.g. a trackpad, or another navigation surface, in particular, but not necessarily, having a touch layer. The purpose is the ability to precisely touch any points of the navigation surface without looking at it and/or the hands. Instead, the only information used involves the positions of the fingers, as presented by pointers visible on the external screen, and the ability to display additional information regarding the interface elements of the game, application or system (e.g. the application icon), over which the finger or fingers are positioned, analogically to hovering over certain interface elements with a mouse pointer, but even if the pointers are not displayed.

The main purpose of the feedback is to display pointers indicating the position of the fingers with respect to the navigation surface, in particular a telephone or a tablet, and to allow the player to easily hit the interface elements of the game or the application with their finger, without looking at the navigation plane, in particular at the telephone or the tablet. The pointers as well as the interface elements may be displayed directly on the navigation surface, in particular in mobile devices, or only on the external screen. Hovering over an interface element with the pointer (visible or not) may display additional information.

In another use of the invention, the user has put on two devices wearable on the user's finger, one per the thumb of each hand, and they are playing a “first person shooter”-type mobile game on a telephone, transmitting the image displayed thereon to a television set. The pointers displayed on the screen of the telephone, or directly on the screen of the television set, present the positions of the thumbs over the screen of the telephone. Due to this, the player may look only at the television set, and still hit the virtual buttons displayed on the interface, on the telephone, with their thumbs, with no need to look at the telephone or the hands.

Another sample use may be such that the user plays a “first person shooter”-type game streamed from a cloud to a television set. They use a telephone and two devices wearable on the user's finger, each one worn on the thumb of each hand. A set consisting of these three devices and an application installed on the telephone constitutes the entire controller. Apart from transmitting information about the tilt of the knob or the rotation of the camera, the telephone also serves as an external navigation surface and point of reference for displaying pointers on the television set. The application transforms the entire screen of the telephone, or a part thereof, into a space corresponding to the proportions of the screen of the television set.

One of the additional uses of the system for determining and presenting the position of the user's finger on a display is to use the system in the form of the so-called feedback, i.e. in the form of pointers visible on an external screen. The position of the pointers corresponds to the position of the thumbs over the screen of the telephone. Due to this, the players may touch selected buttons on the interface while focusing only on the external screen, without looking at their hands. Another application is the use of additional input in the form of one or more buttons placed on the fingertips, due to which players may perform several main actions at the same time by using only their thumbs. The input is additionally supported by the context menu, which allows for performing an even larger number of side actions.

### Methods for Achieving Additional Input

a) Mechanical buttons—switches—placing one or more mechanical buttons of any kind on the fingertip. The controller element abutting on the fingertip may be flexible and/or replaceable, so as to enable matching a proper size to one's finger, or replacing it when worn out. It can also be fixedly attached to the rest of the device.
b) Pressure sensors—mounting one or more pressure sensors of any kind on the fingertip. Each of the pressure sensors may transmit one or more inputs depending on the exerted pressure. The controller element abutting on the fingertip may be flexible and/or replaceable, so as to enable matching a proper size to one's finger, or replacing it when worn out. It can also be fixedly attached to the rest of the device.
c) Touch sensors—Mounting one or more touch sensors of any kind on the fingertip. The controller element abutting on the fingertip may be flexible and/or replaceable, so as to enable matching a proper size to one's finger, or replacing it when worn out. It can also be fixedly attached to the rest of the device.
d) A motion sensor—it may be just a gyroscope, or a gyroscope with an accelerometer, or an entire set of sensors making up a motion sensor located in any place on the finger. When performing a tap/click, the fingers perform a specific micro-movement. The collection of data from the motion sensor allows for discerning this movement/gesture from a normal touch and swipe against the screen. The angle of inclination of the distal phalanx relative to the navigation surface allows for discerning various types of inputs, in particular, but not exclusively, when the motion sensor is placed on the distal phalanx. For example, input A means pressing it with a flat finger, arranged parallel to the navigation surface, with the distal phalanx straightened. Input B is a finger bent at an angle of 45 degrees. Input C means fingers bent at an angle of 90 degrees with respect to the navigation surface and pressing it with the end of the finger (the part of the fingertip directly under the nail). Preferably, motion sensors are additionally supported by machine learning for reaching better precision.
e) a motion sensor+a heart rate monitor/EMG—a heart rate monitor is added to the solution from point d in order to receive additional data
f) An optical sensor—measuring the tension of the finger via infrared light in order to acquire information about the pressure

1. An application for controlling a video game, configured to receive information from a device comprising a touch layer, and data from an additional device for inputting data, and to control the progress of the game depending on this information and these data.

2. The application according to claim 1, wherein it is additionally configured to transmit data to a display or to a device with a display, in which the display has the form of a monitor, a smart TV, a projector or a VR or AR device, the screen of a smartphone or the screen of a tablet, or to an external device.

3. A system for controlling a video game, comprising:
a first control device comprising a processor, memory and the application for controlling a video game according to claim 1,
a device comprising a touch layer configured to determine the position of the user's finger on this touch layer and transmit the information about this position to the first control device,
an additional device for inputting data, configured to transmit the data to the first control device,
a display,
wherein the first control device is configured to receive said information from the device comprising a touch layer, and data from the additional device for inputting data, and to control the progress of the game depending on this information and these data, and to transmit the data to the display,
wherein the display is configured to receive data from the first control device, and to display a video image on their basis.

4. The system according to claim 3, wherein the first control device, the device comprising a touch layer, and the display are a single integrated device, in particular a smartphone or a tablet.

5. The system according to claim 3, wherein the device comprising a touch layer is a smartphone or a tablet, and the touch layer is the screen of the smartphone or the tablet.

6. The system according to claim 3, wherein the first control device is a smartphone, a tablet, a smart TV or a video game console.

7. The system according to claim 3, wherein the additional device for inputting data is a game controller, a gamepad, a joystick or a device wearable on the user's finger.

8. The system according to claim 3, wherein the device comprising a touch layer is configured to transmit information about the position of the user's finger or the input or the data, and/or the triggered actions inputted by means of the finger on the touch layer directly to the first control device.

9. The system according to claim 3, wherein the device comprising a touch layer is configured to transmit information about the position of the user's finger and/or the input or the data, or the triggered actions inputted by means of the finger on the touch layer to the first control device via the additional device for inputting data.

10. The system according to claim 3, wherein the additional device for inputting data is configured to transmit the data directly to the first control device.

11. The system according to claim 3, wherein the additional device for inputting data is configured to transmit the data to the first control device via the device comprising a touch layer.

12. The system according to claim 3, wherein the display is configured to receive additional data from an additional external source or to receive video streaming from the internet, and to display a video image on their basis.

13. The system according to claim 3, wherein the display has the form of a monitor, a smart TV, a projector or a VR or AR device, the screen of a smartphone or the screen of a tablet.

14. The system according to claim 3, wherein the device comprises a touch layer or the additional device for inputting data or the first control device or the display are configured to communicate wirelessly.

15. An application for generating virtual buttons, configured so as to display them over an application or a game.

16-28. (canceled)

29. A system for determining the value of at least one parameter the user's finger, comprising:
a device wearable on the user's finger,
at least one sensor disposed in or on the device wearable on the user's finger,
a third control device comprising a processor, memory and a third control application,
wherein said at least one sensor is adapted to transmit a signal to the third control device,

53. A system for determining and presenting the position of the user's finger on a display, comprising:
a fourth control device configured to determine the position of the finger over the navigation surface, comprising a processor, memory and a fourth control application,
a navigation surface configured to transmit information about its position to the fourth control device,
a display,
an arrangement for determining the position of the user's finger over the navigation surface, wherein said arrangement comprises at least one sensor, and it is configured to determine said position of the user's finger and to transmit information about the determined position to the fourth control device,
wherein the fourth control device is configured to receive said information from the arrangement for determining the position of the user's finger, and to transmit data to the display,
wherein these data comprise a finger position indicator corresponding to the position of the user's finger over the navigation surface,
wherein the display is configured to receive data from the fourth control device, and to display a video image on their basis, including the finger position indicator.

54-64. (canceled)
